(19) United States
(12) Patent Application Publication
(10) Pub. No.: US 2019/0000277 A1
(43) Pub. Date: Jan. 3, 2019

(54) HANDGRIP FOR COOKING VESSELS AND RESPECTIVE FIXING SYSTEM

(71) Applicant: LA TERMOPLASTIC F.B.M. S.R.L., Arsago Seprio (IT)

(72) Inventor: Marco Munari, Cardano Al Campo (IT)

(21) Appl. No.: 16/066,839

(22) PCT Filed: Jul. 14, 2016
(86) PCT No.: PCT/IB2016/054206

§ 371 Date: Jun. 28, 2018

(30) Foreign Application Priority Data
Jan. 15, 2016 (IT) 202016000003539

(51) Int. Cl. A47J 45/06

(52) U.S. Cl. CPC A47J 45/061

(57) ABSTRACT

Described is a system for fixing a handgrip to a cooking vessel which comprises a fixing element in the form of a bridge, configured for being irremovably constrained, at a respective first distal end thereof, to a wall of the cooking vessel and, at a respective second proximal end thereof, to the handgrip. On the lateral surfaces of the fixing element between the first distal end and the second proximal end a plurality di notches, openings and/or inclined walls is provided. The system also comprises a shaped elastic element, configured for being housed and retained inside a corresponding blind hole made at one end of the handgrip, that is to say, the end of the handgrip designed for coupling with the proximal end of the fixing element. The shaped elastic element consists of a metallic bending spring with a constant circular cross section, substantially U-shaped, wherein the two arms of the U are provided with shaped intermediate portions configured for engaging with the corresponding notches, openings and/or inclined walls made on the lateral surfaces of the fixing element, thus obtaining the irreversible coupling between the handgrip and the cooking vessel by inserting the fixing element in the blind hole and by mutual locking between the fixing element and the shaped elastic element.

The present invention relates in general to a handgrip for cooking vessels and, more specifically, to a system for fixing the handgrip to the respective cooking vessel.

As is known, the most common vessels for cooking foods in general, such as, for example, frying pans and saucepans, are provided with handgrips or handles which allow an easy gripping, even when the vessel is full and it is hot. More specifically, frying pan are normally provided with a single handle with an elongated shape, which may be manufactured with a thermosetting and/or thermoplastic material and/or with silicone and which extends radially in a cantilever fashion from the side wall of the frying pan. The handgrip is usually constrained to a fixing element in the form of a bridge, sometimes called “goujon”, which is in turn permanently fixed to the side wall of the pan by welding or rivets.

The irreversible connection between the handgrip and the respective fixing element is usually carried out in the factory and typically requires the use of screws or rivets. According to the prior art, there are also systems for connecting the handgrip with the relative fixing element which comprise elastic connecting elements. These elastic elements can be designed for use on cooking vessels with removable/extractable handgrips and are therefore configured for making a removable connection between the handgrip and the respective fixing element. The elastic force exerted by these connecting elements is therefore not particularly high, as it must be contrasted by a user every time the handgrip is to mounted on/removed from the cooking vessel.

Vice versa, the elastic elements can also be configured for making an irreversible connection between the handgrip and the respective fixing element. This connection therefore requires particularly high elastic forces to prevent the accidental detachment of the handgrip from the respective cooking vessel and it must be necessarily carried out in the factory, since it would not be physically possible for a normal user to contrast the above-mentioned elastic forces.

On some markets and for certain types of cooking vessels the possibility is requested for the end user to mount the handgrip on the cooking vessel, in an irreversible fashion, after the cooking vessel has been purchased. This allows a considerable saving in space during transport and storage of the dismantled cooking vessels, that is to say, free of a protruding and cumbersome protrusion constituted by the handgrip, with consequent advantages in economic terms.

The possibility of mounting the handgrip at home is clearly excluded for the connection using rivets, whilst the use of at least a suitable screwdriver is required for the connection using screws, as well as the application of a correct tightening torque. The use of elastic connecting elements involves, on the other hand, the above-mentioned problems. Basically, if the elastic force exerted by the connecting elements is too low, the user is able to easily attach the handgrip on the cooking vessel, but the accidental detachment of the handgrip may easily occur after a few cycles of use of the vessel. Vice versa, if the elastic force exerted by the connecting elements is too high, the user may not even be able, with the means normally available for him, to carry out the first attachment of the handgrip on the cooking vessel.

Lastly, another drawback of the connection using screws consists in the fact that the screw, following a prolonged use of the cooking vessel and the respective handgrip, as well as following frequent washes, loosens and makes the handgrip unstable. A periodic tightening of the screw is therefore necessary, which in time may adversely affect the functionality of the handgrip.

The main object of the present invention is therefore to provide a handgrip for cooking vessels, more specifically a system for fixing the handgrip to the respective cocking vessel, which is capable of overcoming the above-mentioned drawbacks of the prior art in an extremely simple, economic and particularly functional manner.

In detail, an object of the present invention is to provide a system for fixing a handgrip to a cooking vessel which allows an end user to carry out, with the minimum possible force, the irreversible fixing of the handgrip to the respective cooking vessel.

Another object of the present invention is to provide a system for fixing a handgrip to a cooking vessel which allows an end user to carry out the irreversible fixing of the handgrip to the respective cooking vessel without the use of any tool and with the same safety and reliability as a product preassembled in the factory.

Another object of the present invention is to provide a system for fixing a handgrip to a cooking vessel which allows a stable and long-lasting fixing with a minimum number of components.

Yet another object of the present invention is to provide a system for fixing a handgrip to a cooking vessel wherein the stability of the handgrip is improved with respect to the traditional connecting systems using screws.

These objects according to the present invention are achieved by a system for fixing a handgrip to a cooking vessel according to claim 1.

Further features of the invention are highlighted in the dependent claims, which form an integral part of this description.

The features and the advantages of a system for fixing a handgrip to a cooking vessel according to the present invention will be more evident from the following explanatory and non-limiting description referred to the accompanying schematic drawings in which:

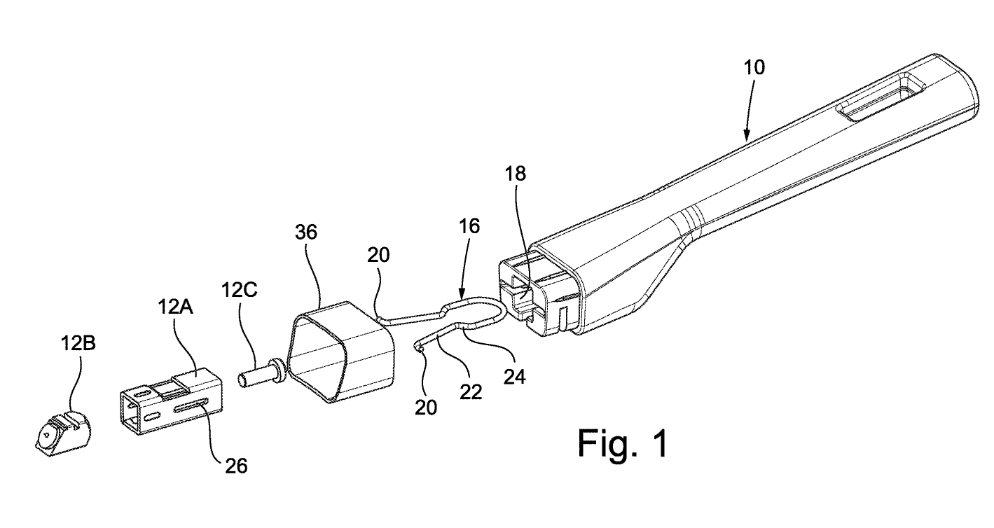

FIG. 1 is an exploded perspective view of a first embodiment of the system for fixing a handgrip to a cooking vessel according to the present invention;

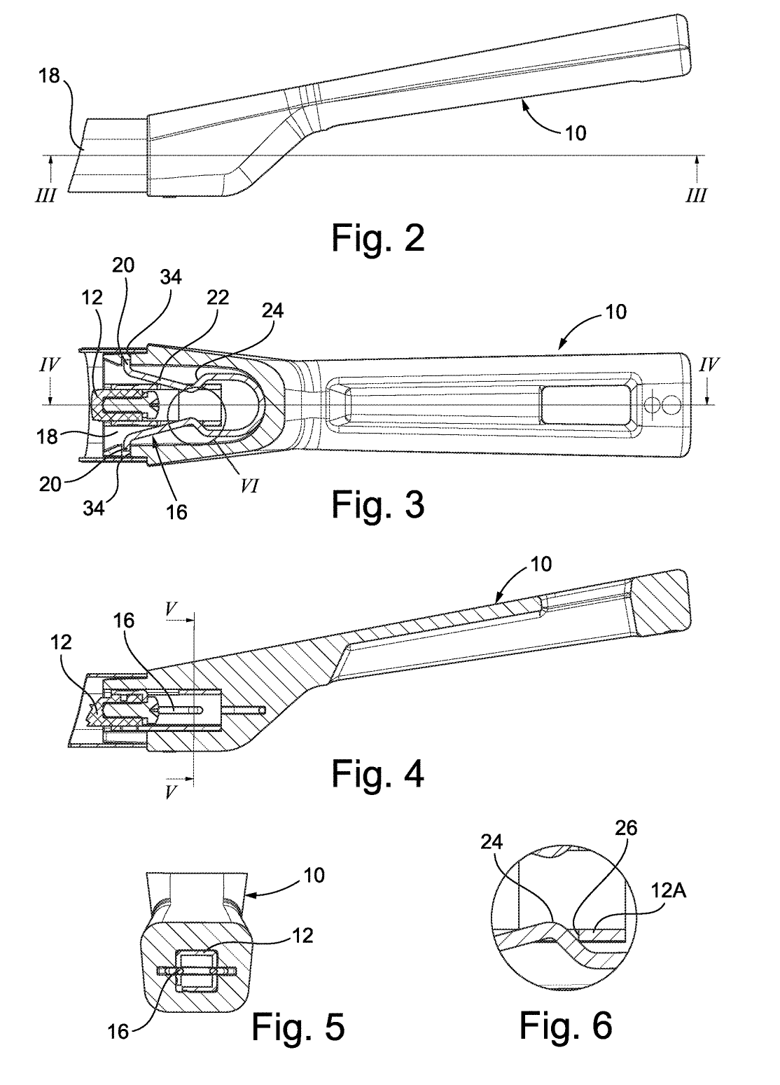

FIG. 2 is a side elevation view of the fixing system of FIG. 1, shown in an assembled configuration;

FIG. 3 is a section view through the line III-III of FIG. 2;

FIG. 4 is a section view through the line IV-IV of FIG. 3;

FIG. 5 is a section view through the line V-V of FIG. 4;

FIG. 6 is an enlarged view of the detail indicated with VI in FIG. 3;

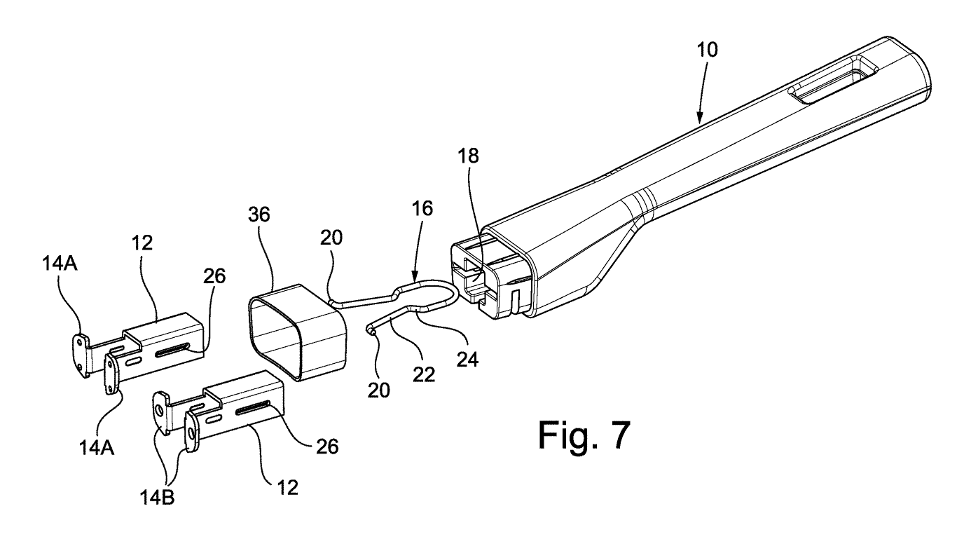

FIG. 7 is an exploded perspective view of a second embodiment of the system for fixing a handgrip to a cooking vessel according to the present invention;

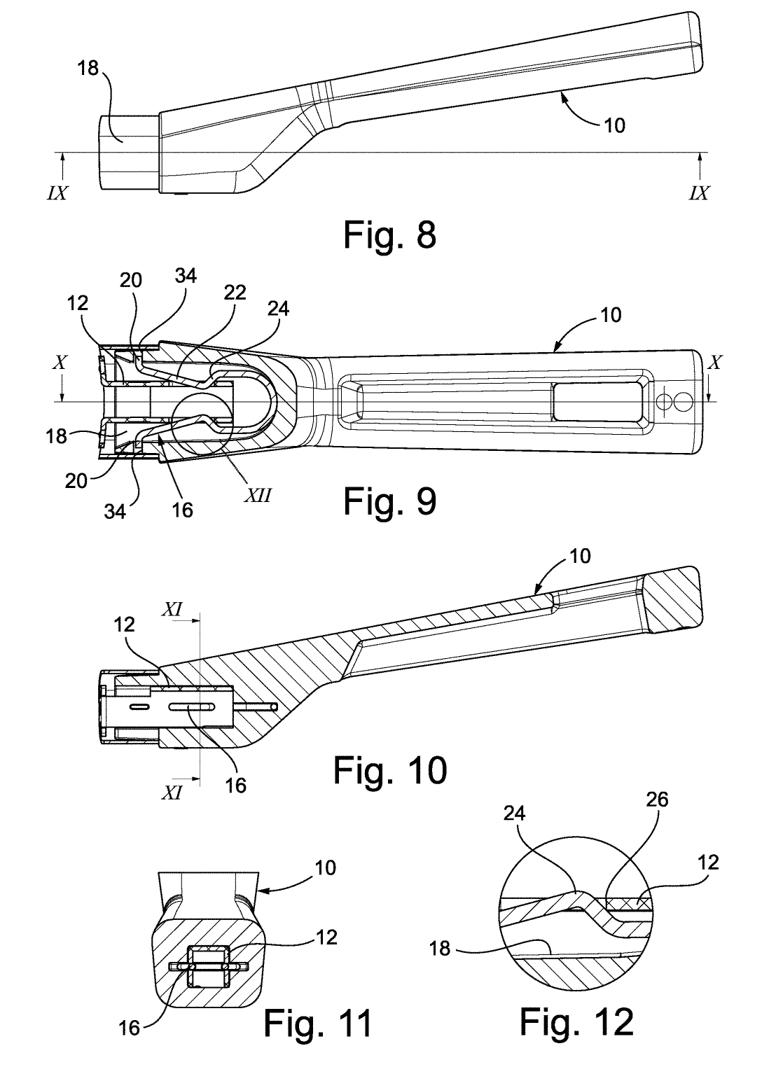

FIG. 8 is a side elevation view of the fixing system of FIG. 7, shown in an assembled configuration;

FIG. 9 is a section view through the line IX-IX of FIG. 8;

FIG. 10 is a section view through the line X-X of FIG. 9;

FIG. 11 is a section view through the line XI-XI of FIG. 10;

FIG. 12 is an enlarged view of the detail indicated with XII in FIG. 9;

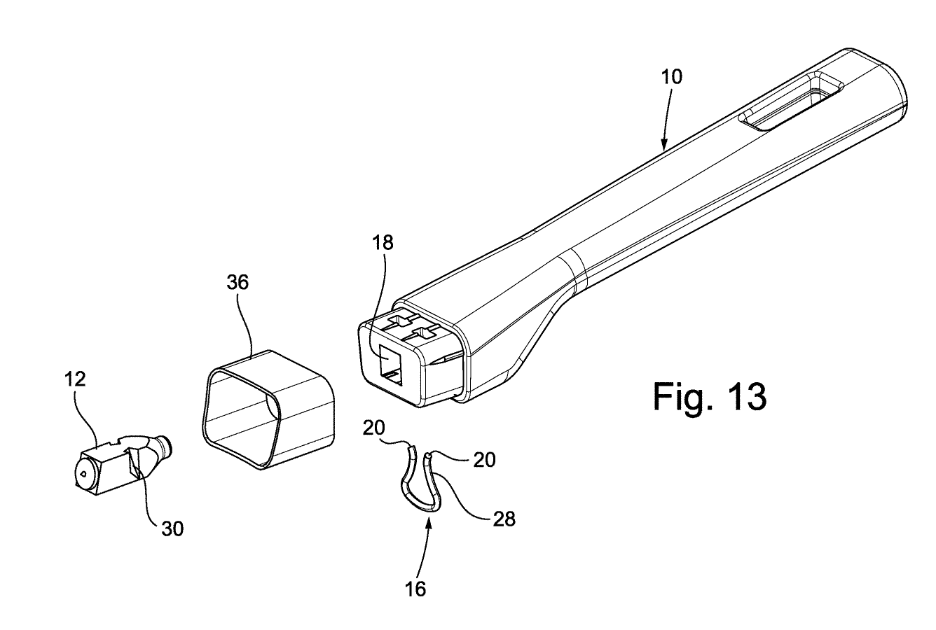

FIG. 13 is an exploded perspective view of a third embodiment of the system for fixing a handgrip to a cooking vessel according to the present invention;

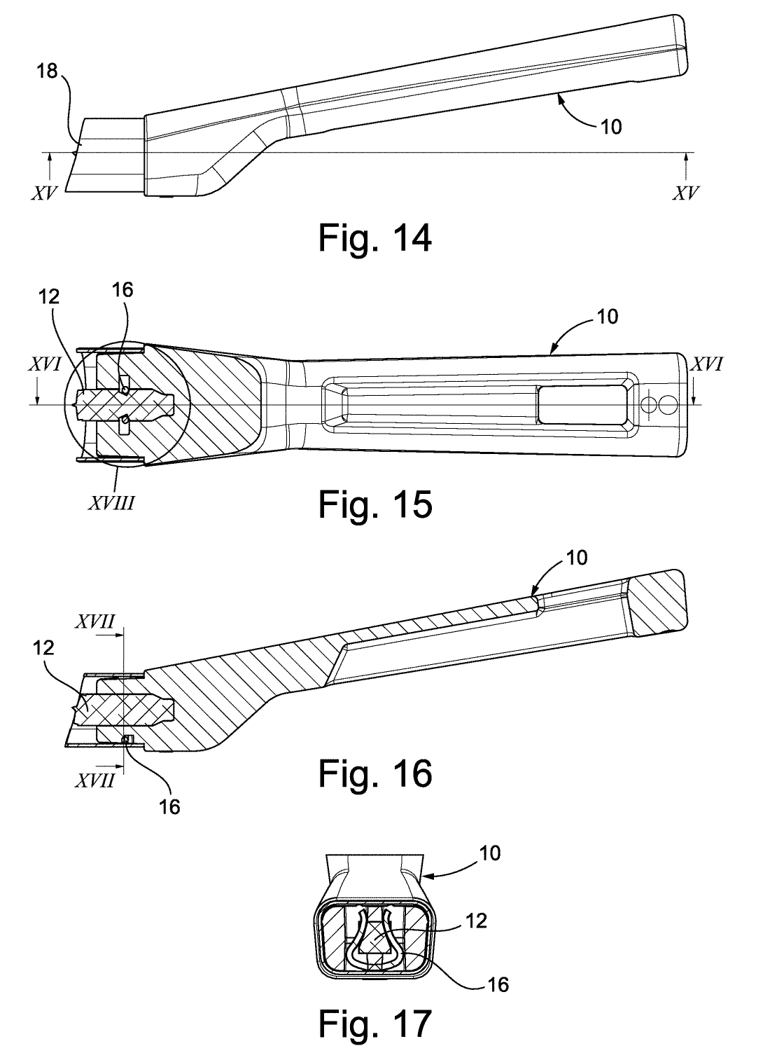

FIG. 14 is a side elevation view of the fixing system of FIG. 13, shown in an assembled configuration;

FIG. 15 is a section view through the line XV-XV of FIG. 14;

FIG. 16 is a section view through the line XVI-XVI of FIG. 15;

FIG. 17 is a section view through the line XVII-XVII of FIG. 16;

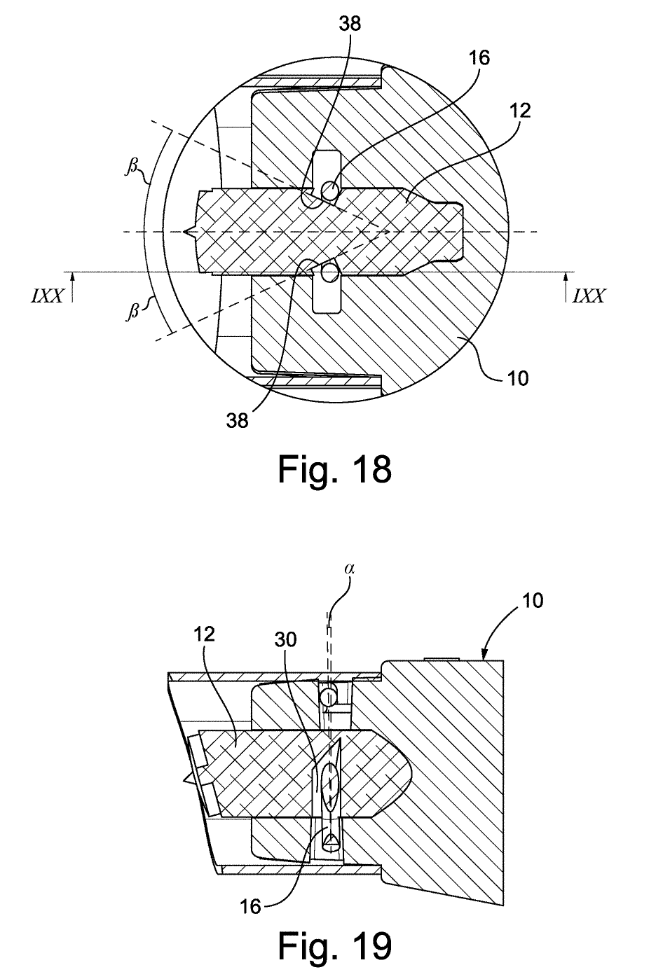

FIG. 18 is an enlarged view of the detail indicated with XVIII in FIG. 15;

FIG. 19 is a section view through the line IXX-IXX of FIG. 18;

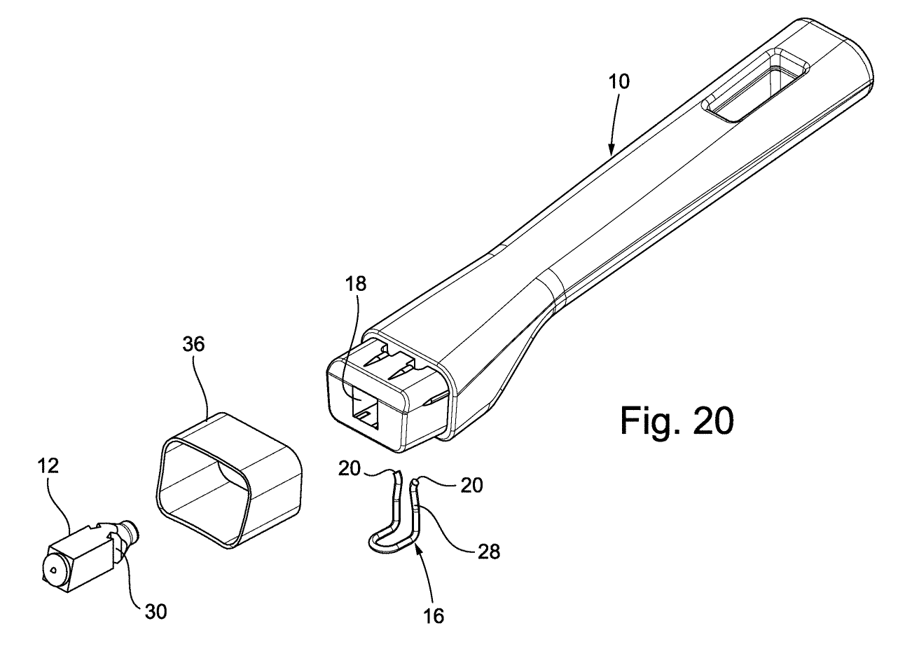

FIG. 20 is an exploded perspective view of a fourth embodiment of the system for fixing a handgrip to a cooking vessel according to the present invention;

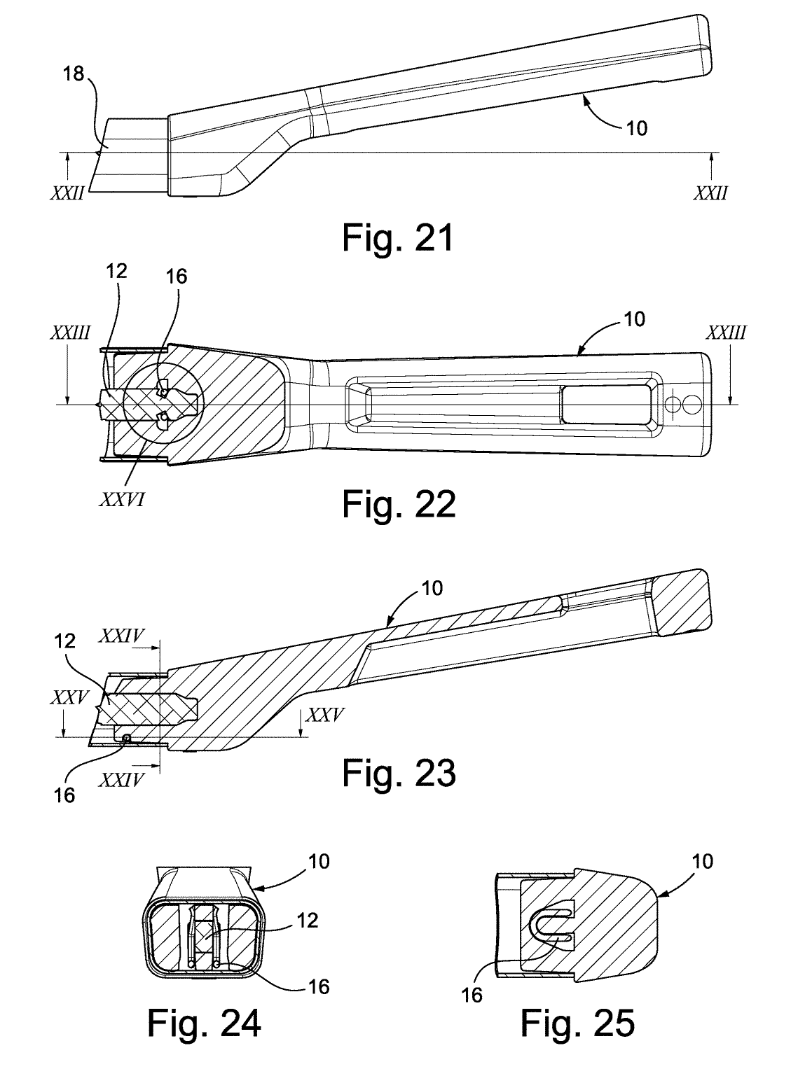

FIG. 21 is a side elevation view of the fixing system of FIG. 20, shown in an assembled configuration;

FIG. 22 is a section view through the line XXII-XXII of FIG. 21;

FIG. 23 is a section view through the line XXIII-XXIII of FIG. 22;

FIG. 24 is a section view through the line XXIV-XXIV of FIG. 23;

FIG. 25 is a section view through the line XXV-XXV of FIG. 23;

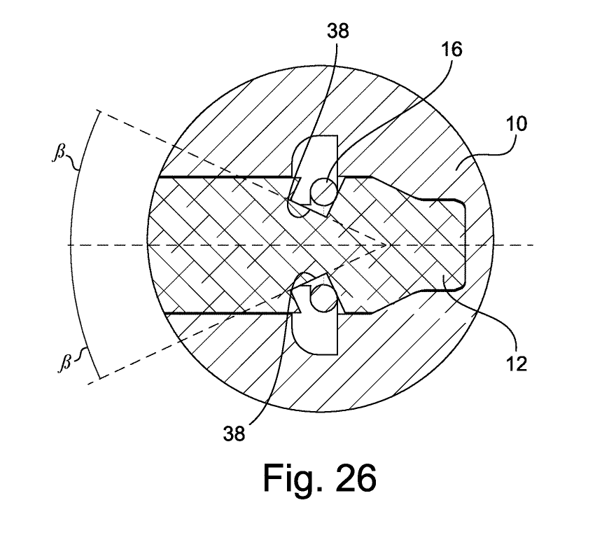

FIG. 26 is an enlarged view of the detail indicated with XXVI in FIG. 22;

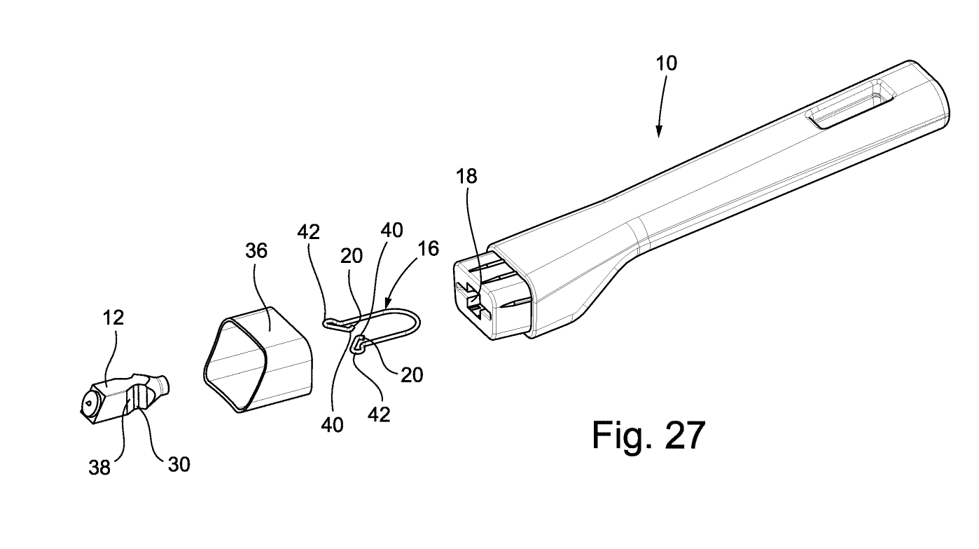

FIG. 27 is an exploded perspective view of a fifth embodiment of the system for fixing a handgrip to a cooking vessel according to the present invention;

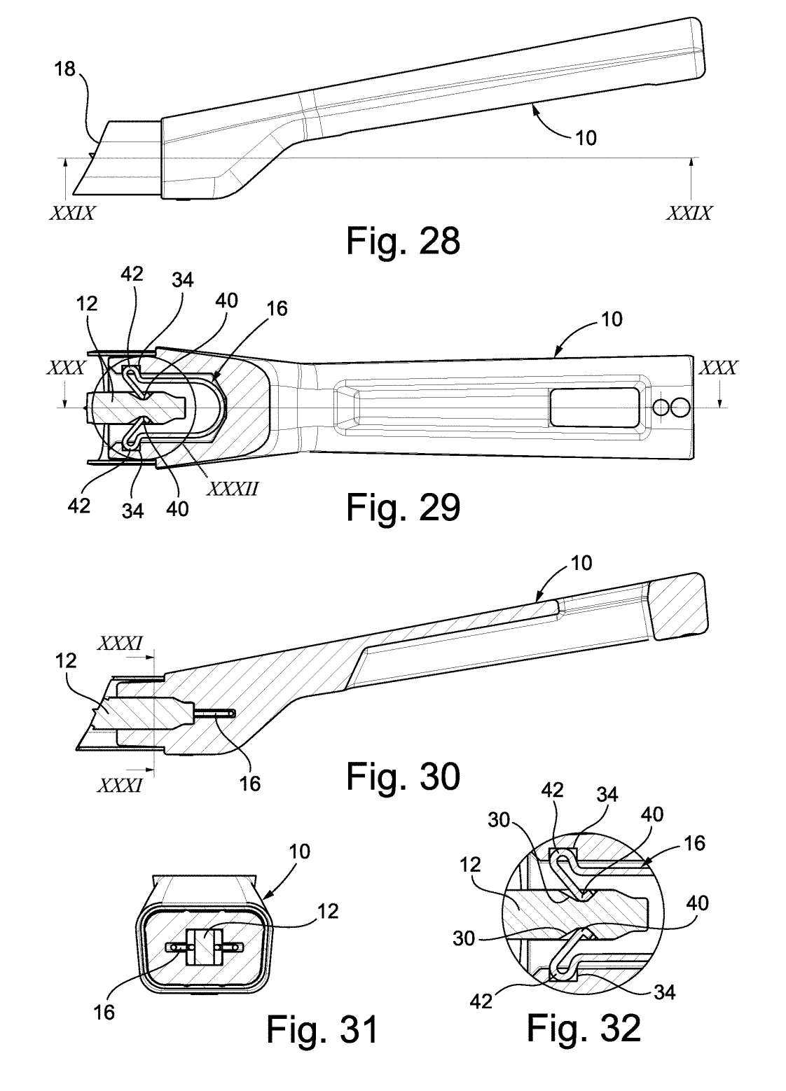

FIG. 28 is a side elevation view of the fixing system of FIG. 27, shown in an assembled configuration;

FIG. 29 is a section view through the line XXIX-XXIX of FIG. 28;

FIG. 30 is a section view through the line XXX-XXX of FIG. 29;

FIG. 31 is a section view through the line XXXI-XXXI of FIG. 30;

FIG. 32 is an enlarged view of the detail indicated with XXXII in FIG. 29;

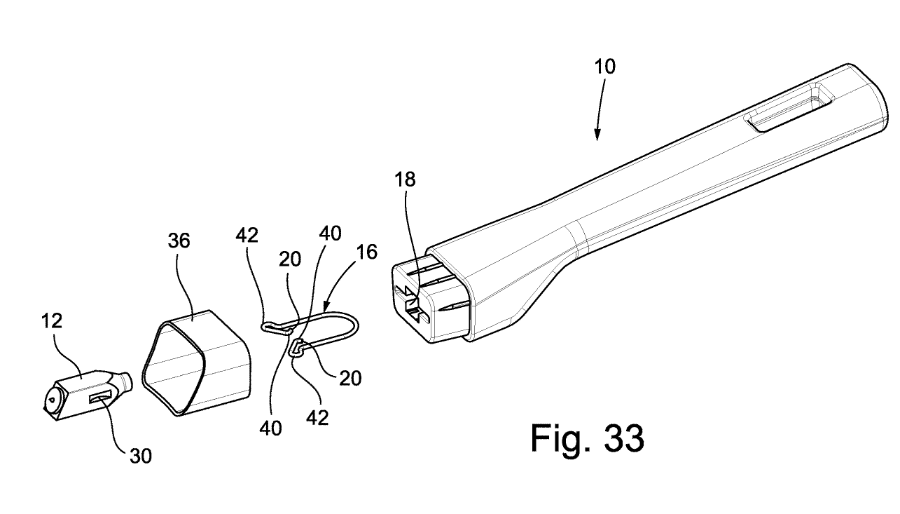

FIG. 33 is an exploded perspective view of a sixth embodiment of the system for fixing a handgrip to a cooking vessel according to the present invention;

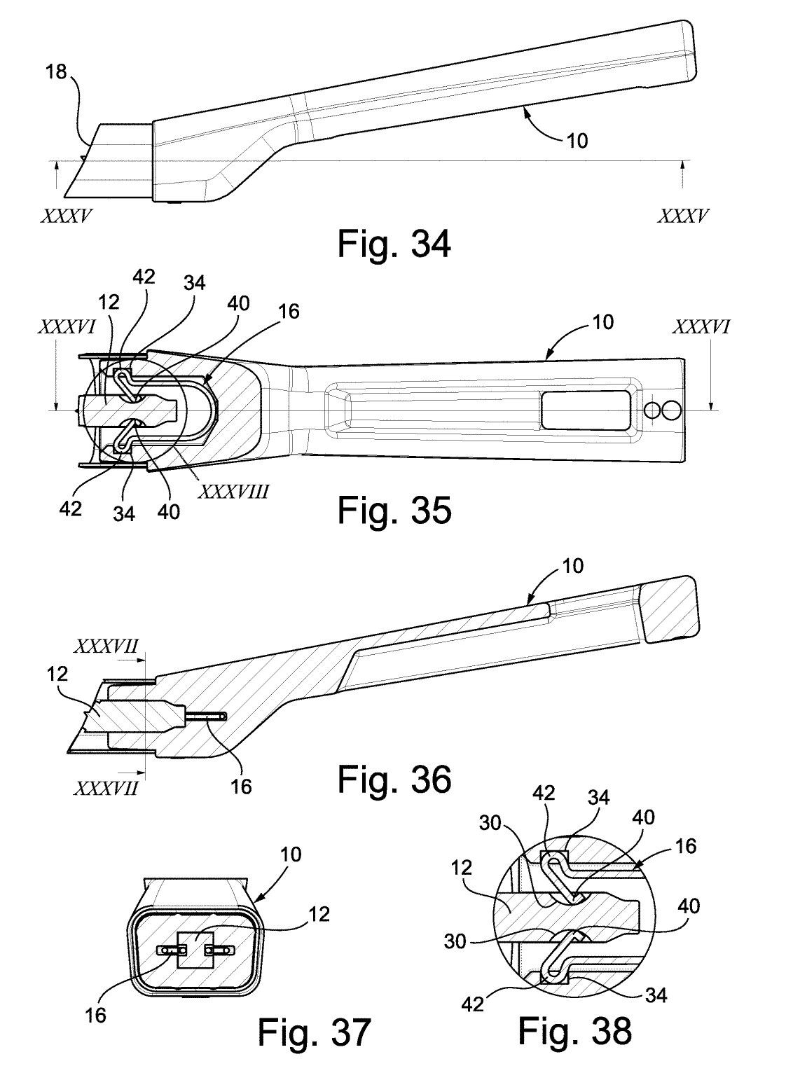

FIG. 34 is a side elevation view of the fixing system of FIG. 33, shown in an assembled configuration;

FIG. 35 is a section view through the line XXXV-XXXV of FIG. 34;

FIG. 36 is a section view through the line XXXVI-XXXVI of FIG. 35;

FIG. 37 is a section view through the line XXXVII-XXXVII of FIG. 36; and

FIG. 38 is an enlarged view of the detail indicated with XXXVIII in FIG. 35.

It should be noted that, in the accompanying drawings and in the following description, equal reference numbers indicate equal elements or elements equivalent to each other.

The drawings illustrate some preferred embodiments of the system for fixing a handgrip 10 to a cooking vessel (not shown) according to the present invention. The handgrip 10 may be shaped in any way, but it most frequently comprises a handle having a curved and elongated shape to allow an easy gripping of the cooking vessel, especially when the latter consists of frying pan with a large diameter and when the handgrip 10 is its only means of gripping. In another embodiment, not shown in the drawings, the handgrip may however consist of a handle which is mounted in pairs on specific cooking vessels, consisting in turn of saucepans. The handgrip 10 is conveniently made of a thermosetting and/or thermoplastic material, or from silicone, suitable for use inside any dishwasher.

The system comprises a fixing element 12 in the form of a bridge, or “goujon”, configured for being irremovably constrained, at a respective first distal end thereof, to a wall of the cooking vessel and, at a respective second proximal end thereof, to the handgrip 10. The fixing element 12 is conveniently made with a metallic material and may consist of a single component, or a plurality of separate components.

With reference to the first embodiment of FIG. 1, the fixing element 12 comprises a first fixing component 12A in the form of a sleeve, internally hollow and provided with a plurality of openings 26 on its lateral surfaces, that is to say, the surfaces between the distal and the proximal end of the fixing element 12. The first fixing component 12A is configured for being irremovably connected to the handgrip 10. The fixing element 12 also comprises a second fixing component 12B, configured for being irremovably connected to the cooking vessel by welding. The fixing element 12 lastly comprises a third fixing component 12C, consisting of a screw and configured for making the first fixing component 12A and the second fixing component 12B integral with each other, as shown for example in FIGS. 3 and 4.

With reference to the second embodiment of FIG. 7, the fixing element 12 consists of an internally hollow sleeve provided with a plurality of openings 26 on its respective lateral surfaces. The sleeve 12 is provided, at the respective first distal end for fixing to the wall of the cooking vessel, with two or more flanges 14A or 14B designed for the coupling with the wall. In detail, the flanges 14A are configured for coupling by welding with the wall of the cooking vessel, the relative fixing element 12 being applicable on steel frying pans. The flanges 14B are instead configured for coupling by means of rivets with the wall of the cooking vessel, the respective fixing element 12 being applicable on aluminium frying pans.

Lastly, with reference to the third, fourth, fifth and sixth embodiments of FIGS. 13 and 20, the fixing element 12 consists of an internally solid single component provided with a plurality of notches 30, with respective inclined internal walls 38, on its respective lateral surfaces. The notches 30 and the respective inclined internal walls 38 are configured for coupling with the handgrip 10, as described in more detail below. This internally solid component is configured for being irremovably connected to the wall of the cooking vessel by welding.

As well as the fixing element 12, the system comprises a shaped elastic element 16, configured for being housed and retained inside a corresponding blind hole 18 made at one end of the handgrip 10, that is to say, the end of the handgrip 10 designed for coupling with the proximal end of the fixing element 12. The shaped elastic element 16 consists of a metallic bending spring with a constant circular cross section, substantially U-shaped, wherein the two arms of the U are provided with shaped intermediate portions configured for engaging with the corresponding notches 30, openings 26 and/or inclined walls 38 made on the lateral surfaces of the fixing element 12. This thereby achieves the irreversible coupling between the handgrip 10 and the cooking vessel by the insertion of the fixing element 12 in the blind hole 18 and by the mutual locking between the fixing element 12 and the spring 16. The fixing system may lastly comprise, in a per se known manner, a ring nut 36, preferably metallic and having the function of a flame plate, designed to cover the end of the handgrip 10 inside which the blind hole 18 is made.

The particular shape of the arms of the spring 16 allows the application of a modest elastic force, of approximately 15 kg_{f}, in the step of attaching the spring 16, and therefore the handgrip 10, to the corresponding fixing element 12 integral with the cooking vessel, thereby facilitating the assembly of the fixing system even at home. Vice versa, the same shape of the arms of the spring 16 requires the application of a high elastic force, of approximately 80 kg_{f}, during any attempt to release the spring 16, and therefore the handgrip 10, from the corresponding fixing element 12 integral with the cooking vessel, thereby ensuring an excellent fatigue resistance of the fixing system.

On the basis of experimental tests, if the above-mentioned elastic force of approximately 80 kg_{f} is applied to carry out any attempt to release the spring 16, the handgrip 10 breaks rather than being pulled out from the corresponding fixing element 12. This is proof of the fact that, with the fixing system according to the invention, the force required to attempt to pull out the handgrip 10 from the corresponding fixing element 12 is so high as to exceed the average breaking load of the most common handles manufactured with thermosetting and/or thermoplastic materials and/or with silicone.

With reference to the first and second embodiments of FIGS. 1 and 7, the spring 16 lies on a horizontal plane (with reference to the position of the cooking vessel when in use) substantially parallel to the development direction of the handgrip 10. The free ends 20 of the arms of the spring 16, when the spring 16 is retained inside the corresponding blind hole 18 of the handgrip 10, face towards the opening of the blind hole 18 and they insert by pressure fitting in respective abutment slots 34 made in the blind hole 18.

Each shaped intermediate portion of the spring 16 comprises, starting from the respective free ends 20 and with reference to the position of these free ends 20, a first diverging portion 22, configured for facilitating the sliding of the spring 16 on its respective lying plane and around the lateral surfaces of the fixing element 12 (FIG. 7) or of the respective sleeve-shaped first fixing component 12A (FIG. 1). Each shaped intermediate portion of the spring 16 also comprises, again starting from the respective free ends 20 and with reference to the position of these free ends 20, a second converging portion 24, configured for engaging with the corresponding openings 26 made on the lateral surfaces of the fixing element 12 (FIG. 7) or of the respective sleeve-shaped first fixing component 12A (FIG. 1). These openings 26 form fastening seats which keep the spring 16, and therefore the handgrip 10, blocked with respect to the fixing element 12 integral with the cooking vessel.

Operatively, in the step of assembling the handgrip 10 on the fixing element 12, an axial movement of the handgrip 10 towards the respective fixing element 12 causes firstly a widening of the spring 16, due to the effect of its sliding around the lateral surfaces of the fixing element 12 or of the first sleeve-shaped fixing component 12A. When the second converging portion 24 of the spring 16 engages with the corresponding openings 26 made on the lateral surfaces of the fixing element 12 or of the first sleeve-shaped fixing component 12A, the spring 16 relaxes and any new axial movement of the handgrip 10 with respect to the fixing element 12 is prevented.

With reference to the third embodiment of FIG. 13, the spring 16 lies on a vertical plane (with reference to the position of the cooking vessel when in use) substantially perpendicular to the development direction of the handgrip 10. The free ends 20 of the arms of the spring 16, when the spring 16 is retained inside the corresponding blind hole 18 of the handgrip 10, face upwards (again with reference to the position of the cooking vessel when in use). Preferably, with reference to FIG. 19, the free ends 20 of the arms of the spring 16 are inclined forwards, that is to say, towards the wall of the cooking vessel, by an angle a equal to approximately 1° with respect to a vertical plane, so as to reduce the clearances inside the blind hole 18.

Each shaped intermediate portion of the spring 16 comprises a central throttled or tapered portion 28, configured for engaging with the corresponding notches 30 made on the lateral surfaces of the fixing element 12. These notches 30 form fastening seats which keep the spring 16, and therefore the handgrip 10, blocked with respect to the fixing element 12 integral with the cooking vessel.

The fixing element 12 is provided with a rounded entrance portion 32, obtained on its respective second proximal end and configured for widening the central throttled or tapered portion 28 of the spring 16 in the step of assembling the handgrip 10 on the fixing element 12. Preferably, each notch 30 is internally provided with one or more walls 38 inclined with an acute angle p with respect to a vertical centerline plane of the fixing element 12. With these inclined walls 38 each notch 30 has a wedge shape in a horizontal cross section, as shown in FIG. 18, so as to prevent the spring 16 from uncoupling from the fixing element 12 in the assembled configuration of the system.

The fourth embodiment of FIG. 20 refers to a fixing system very similar to that of FIGS. 13-19. The only difference consists in the shape of the spring 16. In fact, in this embodiment, the free ends 20 of the arms of the spring 16 and the central throttled or tapered portion 28 lie on a vertical plane (with reference to the position of the cooking vessel when in use) substantially perpendicular to the development direction of the handgrip 10, whilst the curved portion of the spring 16, where the respective arms join, lies on a horizontal plane (again with reference to the position of the cooking vessel when in use) substantially parallel to the development direction of the handgrip 10.

With reference to the fifth and sixth embodiments of FIGS. 27 and 33, the spring 16 again lies on a horizontal plane (with reference to the position of the cooking vessel when in use) substantially parallel to the development direction of the handgrip 10. In this embodiment the shaped intermediate portion of each arm of the spring 16 also comprises, starting from the respective free ends 20 and with reference to the position of these free ends 20, a first portion 40 bent inwards, configured for engaging with a corresponding notch 30 made on one of the lateral surfaces of the fixing element 12. The shaped intermediate portion of each arm of the spring 16 also comprises, again starting from the respective free ends 20 and with reference to the position of these free ends 20, a second portion 42 bent outwards, configured for inserting by pressure fitting in a respective abutment slot 34 made in the blind hole 18.

In the fifth embodiment each notch 30 of the fixing element 12, as well as the respective internal inclined walls 38, extend along a substantially vertical direction (with reference to the position of the cooking vessel when in use), that is to say, a direction substantially perpendicular to the plane on which the spring 16 lies. In the sixth embodiment, however, the only difference with respect to the fifth embodiment consists in the fact that each notch 30 of the fixing element 12, and the respective internal inclined walls 38, extend along a substantially horizontal direction (with reference to the position of the cooking vessel when in use), that is to say, a direction substantially parallel to the plane on which the spring 16 lies.

It is thus seen that the system for fixing a handgrip to a cooking vessel according to the present invention achieves the above-mentioned objects.

The system for fixing a handgrip to a cooking vessel as described above can be modified and adapted in several ways without thereby departing from the scope of the inventive concept. Moreover, all the details may be substituted for technically equivalent elements. In practice, the embodiments of the invention may be made from any material, and in any size, depending on the technical requirements.

The scope of protection of the invention is therefore defined by the accompanying claims.

1. A system for fixing a handgrip to a cooking vessel, the system comprising:
a fixing element in the form of a bridge, configured for being irremovably constrained, at a respective first distal end thereof, to a wall of the cooking vessel and, at a respective second proximal end thereof, to the handgrip, on the lateral surfaces of the fixing element between the first distal end and the second proximal end a plurality of notches, openings and/or inclined walls being provided; and
a shaped elastic element, configured for being housed and retained inside a corresponding blind hole made at one end of the handgrip, such that the one end of the handgrip is designed for coupling with the proximal end of the fixing element,
wherein the shaped elastic element consists of a metallic bending spring with a constant circular cross section, substantially U-shaped,
two arms of the U are provided with shaped intermediate portions configured for engaging with the corresponding notches, openings and/or inclined walls made on the lateral surfaces of the fixing element to obtain the irreversible coupling between the handgrip and the cooking vessel by inserting the fixing element in the blind hole and by mutual locking between said fixing element and the shaped elastic element.

2. The system according to claim 1, wherein the fixing element comprises:
a first internally hollow sleeve-shaped fixing component provided with said plurality of openings on its respective lateral surfaces, said first fixing component being configured for being irremovably connected to the handgrip;
a second fixing component, configured for being irremovably connected to the cooking vessel; and
a third fixing component, configured for making the first fixing component and the second fixing component integral with each other.

3. The system according to claim 1, the fixing element consists of an internally hollow sleeve provided with the plurality of openings on its respective lateral surfaces, said sleeve being also provided, at the respective first distal end for fixing to the wall of the cooking vessel, with two or more flanges designed for the coupling with said wall.

4. The system according to claim 2, wherein the spring lies on a horizontal plane substantially parallel to the development direction of the handgrip with reference to the position of the cooking vessel when in use, the free ends of the arms of the spring, when said spring is retained inside the corresponding blind hole of the handgrip, facing towards the opening of the blind hole and being inserted by pressure fitting in respective abutment slots made in said blind hole.

5. The system according to claim 4, wherein each shaped intermediate portion of the spring comprises, starting from the respective free ends and with reference to the position of said free ends:
a first diverging portion, configured for facilitating the sliding of the spring on its respective lying plane and around the lateral surfaces of the fixing element; and
a second converging portion, configured for engaging with the corresponding openings made on the lateral surfaces of the fixing element, said openings forming fastening seats which keep the spring, and therefore the handgrip, blocked with respect to the fixing element integral with the cooking vessel.

6. The system according to claim 1, wherein the fixing element consists of an internally solid single component provided with a plurality of notches, with respective inclined internal walls, on the respective lateral surfaces, said internally solid component being configured for being irremovably connected to the wall of the cooking vessel by welding.

7. The system according to claim 6, wherein each notch is internally provided with one or more walls inclined with an acute angle (β) with respect to a vertical centerline plane of the fixing element, said inclined walls giving to each notch a wedge shape in a horizontal cross section, so as to prevent the spring from uncoupling from the fixing element in the assembled configuration of the system.

8. The system according to claim 7, wherein the spring lies on a vertical plane substantially perpendicular to the development direction of the handgrip with reference to the position of the cooking vessel when in use, the free ends of the arms of the spring, when said spring is retained inside the corresponding blind hole of the handgrip, facing upwards, again with reference to the position of the cooking vessel when in use.

9. The system according to claim 8, wherein the free ends of the arms of the spring are inclined forwards, that is to say, towards the wall of the cooking vessel, by an angle (α) equal to approximately 1° with respect to a vertical plane, so as to reduce the clearances inside the blind hole.

10. The system according to claim 8, wherein each shaped intermediate portion of the spring comprises a central throttled or tapered portion, configured for engaging with the corresponding notches made on the lateral surfaces of the fixing element, said notches forming fastening seats which keep the spring, and therefore the handgrip, blocked with respect to the fixing element integral with the cooking vessel.

11. The system according to claim 10, wherein the fixing element is provided with a rounded entrance portion, obtained on its respective second proximal end and configured for widening the central throttled or tapered portion of the spring in the step of assembling the handgrip on said fixing element.

12. The system according to claim 10, wherein the free ends of the arms of the spring and the central throttled or tapered portion lie on a vertical plane, with reference to the position of the cooking vessel when in use, substantially perpendicular to the development direction of the handgrip, whilst the curved portion of the spring, where the respective arms join, lies on a horizontal plane, again with reference to the position of the cooking vessel when in use, substantially parallel to the development direction of the handgrip.

13. The system according to claim 7, wherein the spring lies on a horizontal plane substantially parallel to the development direction of the handgrip with reference to the position of the cooking vessel when in use, the shaped intermediate portion of each arm of the spring comprising, starting from the respective free ends and with reference to the position of said free ends:
a first portion bent inwards, configured for engaging with a corresponding notch made on one of the lateral surfaces of the fixing element; and
a second portion bent outwards, configured for inserting by pressure fitting in a respective abutment slot made in the blind hole.

14. The system according to claim 13, wherein each notch, and the respective internal inclined walls, extend along a substantially vertical direction, that is to say, a direction substantially perpendicular to the lying plane of the spring with reference to the position of the cooking vessel when in use.

15. The system according to claim 13, wherein each notch, and the respective internal inclined walls, extend along a substantially horizontal direction, that is to say, a direction substantially parallel to the lying plane of the spring with reference to the position of the cooking vessel when in use.

16. The system according to claim 3, wherein the spring lies on a horizontal plane substantially parallel to the development direction of the handgrip with reference to the position of the cooking vessel when in use, the free ends of the arms of the spring, when said spring is retained inside the corresponding blind hole of the handgrip , facing towards the opening of the blind hole and being inserted by pressure fitting in respective abutment slots made in said blind hole .
